(19) United States
(12) Patent Application Publication
(10) Pub. No.: US 2003/0055772 A1
(43) Pub. Date: Mar. 20, 2003

(54) Method and apparatus to facilitate transactions between buyers and sellers

(76) Inventor: Michael Goldstein, West Palm Beach, FL (US)

Correspondence Address: IP Department, SCHNADER HARRISON SEGAL & LEWIS, 36th Floor, 1600 Market Street, Philadelphia, PA, 19103, US

(21) Appl. No.: 09/875,841

(22) Filed: Jun. 6, 2001

Related U.S. Application Data
(60) Provisional application No. 60/209,492, filed on Jun. 6, 2000.

(51) Int. Cl. G06F 17/60

(52) U.S. Cl. 705/37

(57) ABSTRACT

The present invention is directed to a system for facilitating a transaction between a buyer and a plurality of sellers for a product sold at quoted rate that may include establishing an information exchange system for exchanging information between the buyer and the plurality of sellers, wherein the information exchange system is independent of the buyer and the plurality of sellers. A profile may be established for the buyer (containing buyer information), and for each of the independent plurality of sellers that contains seller information for said individual seller, as well as product information for at least one of the products offered by each individual seller and statistics for the individual seller. A request for product information may be received from the buyer, and product information may be compiled from the individual seller profiles using the buyer information and the seller information. This product information may be transmitted to the buyer, and a rate request for said product may be received from the buyer based upon the product information. The rate request may be forwarded to the independent plurality of sellers, and a reply may be received from at least one of the sellers. The reply may preferably contain one or more selected from the group consisting of the quoted rate, an alternate product proposal, and a refusal. The reply may then be forwarded to the buyer.

### CROSS-REFERENCE TO RELATED APPLICATION

This application is a continuation of U.S. Provisional Patent Application Serial No. 60/209,492, filed Jun. 5, 2000, now abandoned.

### STATEMENT REGARDING FEDERALLY SPONSORED RESEARCH

Not applicable.

### REFERENCE TO MICROFICHE APPENDIX

Not applicable.

### BACKGROUND OF THE INVENTION

1. Field of the Invention

The present invention relates to a system to facilitate transactions between buyers and sellers, and more particularly to an Internet based system to facilitate transactions among buyers, sellers, special-offer sellers, and seller groups.

2. Description of the Prior Art

Most goods and services sold, whether at retail or business to business, are generally done so by using a seller-driven protocol, whereby the seller sets a price and the buyer decides whether or not to accept that price. Prices for some services, such as travel services, might change frequently, but the buyer must still wait for the seller to offer a price he finds acceptable. Regardless of the system used, e.g. an auction system, reservations, etc., price is determined either directly or indirectly by the seller, who is trying to attract buyers.

Because of this, there has been a proliferation in the prior art of new, buyer-driven, electronic bidding and sale/booking systems for everything from airline tickets to used cars to human kidneys. While not limited thereto, much of this new technology focuses on the travel industry, e.g. bidding/booking airline tickets, hotel rooms, cars, etc.

For example, U.S. Pat. No. 5,794,207 (the contents of which are hereby incorporated by reference herein) discloses a method and apparatus for effectuating bilateral buyer-driven commerce. The '207 patent discloses using a computer to facilitate a transaction between a buyer and a plurality of sellers by inputting a conditional purchase offer; inputting a payment identifier specifying a credit card account; outputting the conditional purchase offer to the plurality of sellers after receiving the payment identifier; inputting an acceptance from a seller; and providing a payment to the seller by using the payment identifier.

While such systems are effective reducing the process of weeding out offers from multiple sellers, these systems have the significant disadvantage that they are unattractive to the seller, who must now down bid its price at auction with its competitors. There is no inherent incentive for the seller to participate in the system, which is ultimately disadvantageous to the buyer as well. Moreover, such systems require the use of the buyer's credit card for operation of the system (which is a disadvantage to the buyer), and require an immediate purchase for any incentive to be achieved (otherwise there is no incentive to the seller).

In addition, because of the way such systems are structured, their application is limited to the retail market, that is, business to consumer (or “B2C”) sales. They cannot be used to facilitate electronic transactions among those in the business sector (business to business or “B2B” transactions) and between consumers and business associations, such as tourist boards.

Accordingly, a workable and efficient system is needed for providing a system to facilitate electronic transactions among all of these groups, while simultaneously providing incentives to each and substantially reducing or eliminating the disadvantages noted above.

### SUMMARY OF THE INVENTION

The present invention is directed to a information exchange system for facilitating a transaction between a buyer and a plurality of sellers for a product sold at quoted rate that may include establishing an information exchange system for exchanging information between the buyer and the plurality of sellers, wherein the information exchange system is independent of the buyer and the plurality of sellers. A profile may be established for the buyer (containing buyer information), and for each of the independent plurality of sellers that contains seller information for said individual seller, as well as product information for at least one of the products offered by each individual seller and statistics for the individual seller. A request for product information may be received from the buyer, and product information may be compiled from the individual seller profiles using the buyer information and the seller information.

This product information may be transmitted to the buyer, and a rate request for said product may be received from the buyer based upon the product information. The rate request may be forwarded to the independent plurality of sellers, and a reply may be received from at least one of the sellers. The reply may preferably contain one or more selected from the group consisting of the quoted rate, an alternate product proposal, and a refusal. The reply may then be forwarded to the buyer.

A special offer seller profile may also be established for at least one special offer sellers, wherein the special offer seller is independent of the information exchange system. The special offer seller profile may contain seller information for the special offer seller, special offer formation for at least one product offered by the special offer seller, and statistics for the special offer seller. At least one of the special offers is preferably transmitted to the buyer based upon the buyer information.

In addition, a seller group profile may be established for at least one seller group, wherein the seller group is independent of the information exchange system. The seller group profile may contain seller group information for the seller group, offer formation for at least one product offered by said seller group, and statistics for said seller group. At least one of the seller group offers is preferably transmitted to the buyer based upon the buyer information.

### BRIEF DESCRIPTION OF THE DRAWINGS

FIG. 1 is a block diagram illustrating a preferred embodiment of the present invention used over the Internet.

FIGS. 2(a)-(f) are block diagrams illustrating the elements of the preferred embodiment incorporated in the Information Exchange System of the present invention.

FIGS. 3(a)-(h) are flow charts illustrating operation of the preferred embodiment of the present invention by a consumer buyer.

FIGS. 4(a)-(h) are flow charts illustrating operation of the preferred embodiment of the present invention by an operator seller.

FIGS. 5(a)-(h) are flow charts illustrating operation of the preferred embodiment of the present invention by a supplier seller.

FIGS. 6(a)-(h) are flow charts illustrating operation of the preferred embodiment of the present invention by a seller group.

### DETAILED DESCRIPTION OF THE PREFERRED EMBODIMENT

The present invention will be understood more fully from the detailed description given below and from the accompanying drawings of preferred embodiments of the invention, which, however, should not be taken to limit the invention to a specific embodiment but are for explanation and understanding only.

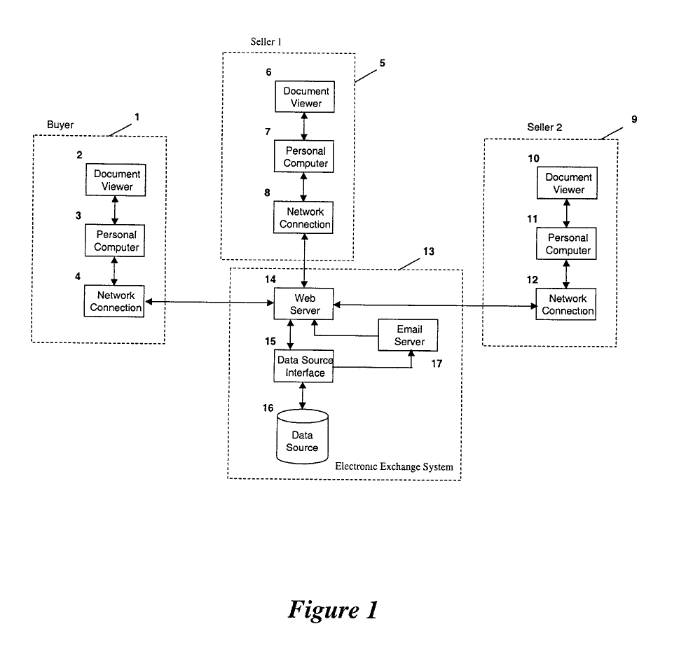

FIG. 1 is a schematic demonstrating the typical components used in a preferred embodiment of the invention when used over the Internet. Those of ordinary skill in the art will appreciate that the present invention, while described below in connection with its use over the Internet, is certainly not limited thereto.

As shown in FIG. 1, this embodiment of the invention includes Buyer Access 1, which includes Document Viewer 2, Computer 3, and Network Connection 4 (described in more detail below), which allows buyers to access the system of the present invention. The buyer is not limited to consumers, but may be other businesses, operators, operator groups, etc. Similarly, this embodiment includes Seller Access 5, which likewise includes Document Viewer 6, Computer 7, and Network Connection 8. As with the Buyer, Seller 1 and Seller 2 are also not particularly limited. The present invention also preferably includes a second Seller Access 9, which includes Document Viewer 10, Computer 11, and Network Connection 12.

Buyer, Seller 1, and Seller 2 communicate with each other, and have their transactions facilitated by, Information Exchange System 13. Information Exchange System 13, preferably includes at least an Internet Web Server 14, a Data Source Interface 15, a Data Source 16, and an Email Server 17.

To input and extract information from Information Exchange System 13, an electronic document, such as a Web page created using HTML, is loaded by Buyer, Seller 1, or Seller 2 into their respective Document Viewer. Each Document Viewer may be any software application capable of viewing electronic documents and loading additional electronic documents from within the original document, such as through the use of a hypertext link or form (although not limited thereto).

For example, the Document Viewer could include a Web browser, such as Navigator from Netscape Communications or Microsoft's Internet Explorer. The electronic document may be loaded automatically when the Document Viewer is first started, or may be opened into the viewer by the user from a file stored locally or at a remote address. For example, the user may load the document by typing the document's address into the Web browser's command line.

Each Document Viewer may be accessed by the user through any of a number of computer systems, such as through the use of a terminal connected to a mainframe system, from a personal computer, over computer connected to a local computer network, over a virtual private network, etc.

Each Document Viewer is preferably connected to Information Exchange System 13 through the Internet along with each respective Computer via each Network Connection. The Network Connection is typically made through local telephone lines using an analog, ISDN, or DSL connection, though it can be over a direct network connection, such as an Ethernet network and leased line. Each Network Connection may be a computer network that routes any requests from each Document Viewer to the appropriate location of Information Exchange System 13 on the Internet. This operation is well known to those of skill in the art. The Network Connection connects its Document Viewer to Web Server 14 in Information Exchange System 13 through any of a number of well-known connection schemes, such as through the use of leased lines.

Web Server 14 is typically a software application running on a computer that is capable of forwarding or processing requests from the Document Viewer. For example, Web Server in 14 may include any one of a number of well-known server applications, such as those based upon the NSCA Web server, the Apache Web server, etc. Web Server 14 passes a document request from the Document Viewer to Data Source Interface 15 for accessing Data Source 16. Data Source 16 contains all of the information provide by each of Buyer, Seller 1, and Seller 2, as described in more detail below.

After a document, such as an HTML form (or series of forms), is loaded into the Document Viewer, the user enters in the appropriate information and may activate a hypertext link or form “Submit” button, generating a signal back to Data Source Interface 15. This is preferably in the form of an HTTP request sent over the Internet using TCP/IP and possibly a Secure Socket Layer (“SSL”). The request may be routed through the Network Connection and through Web Server 14 to Data Source Interface 15. It will be appreciated that the details of HTTP operation in conjunction with TCP/IP and SSL are well known to those of ordinary skill in the art and will, therefore, not be elaborated on here.

When the HTTP request is received by Data Source Interface 15, it accesses Data Source 16 to retrieve the requested information based upon the signal from the Document Viewer. In one embodiment of the invention, a common gateway interface (“CGI”) program, well known to those of skill in the art, may be used to parse the data from the Document Viewer. This program acts as an interface between the Web Server 14 and/or Data Interface 15 and Data Source 16 by executing a set of instructions. The interaction of Web servers and CGI programs and the sending of information therebetween is well known to those of ordinary skill in the art.

The CGI program may extract the document information from the information passed to it by the server and retrieve the appropriate information from Data Source 16. This may be accomplished in a number of ways known to those of ordinary skill in the art. For example, if the CGI program is a PERL script or some other API, a database access module can be used to interface with the majority of commercial relational database applications. Examples of such databases include Oracle, Sybase, SQL Server, and the like. Of course, it is also possible for these systems to be accessed directly by Web Server 14 using their own interface tools.

Information is submitted to or extracted from Data Source 16, depending on the signal sent by the Document Viewer. Data Source Interface 15 then generates a signal back to the Document Viewer through Web Server 14. Email Server 17 is also used to communicate with Buyer, Seller 1, and/or Seller 2, preferably using a known transmission protocol, such as SMTP (Simple Mail Transfer Protocol).

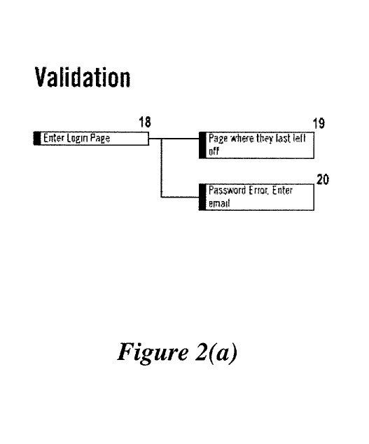

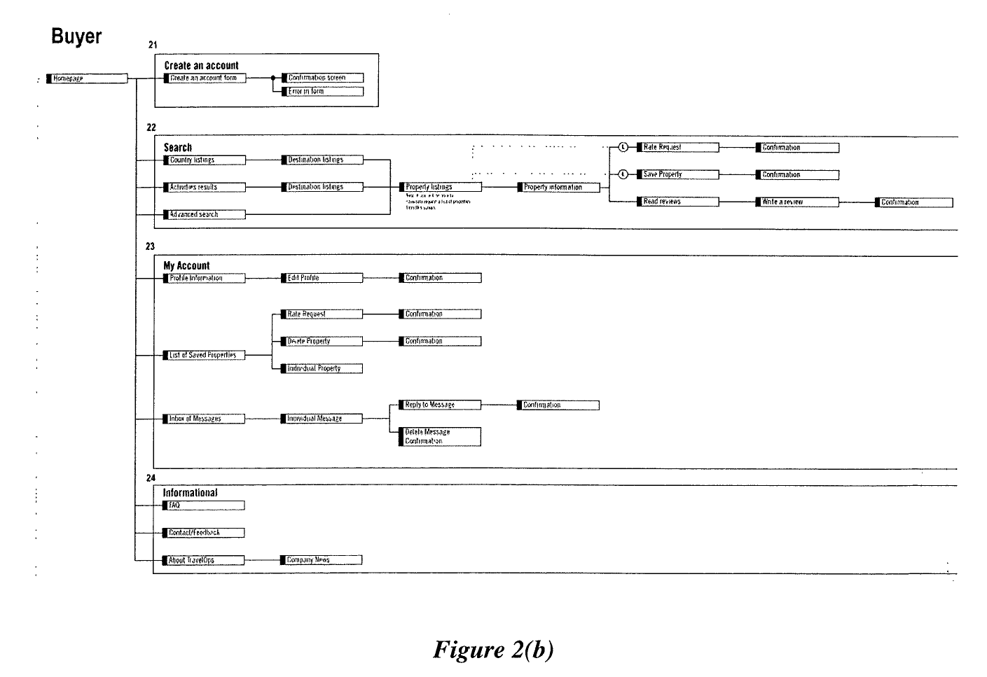

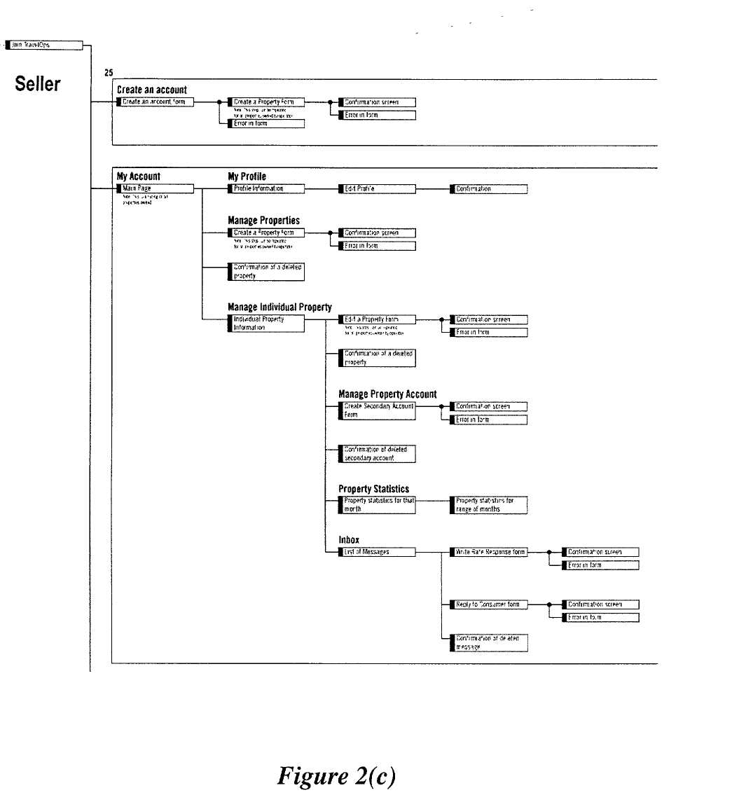

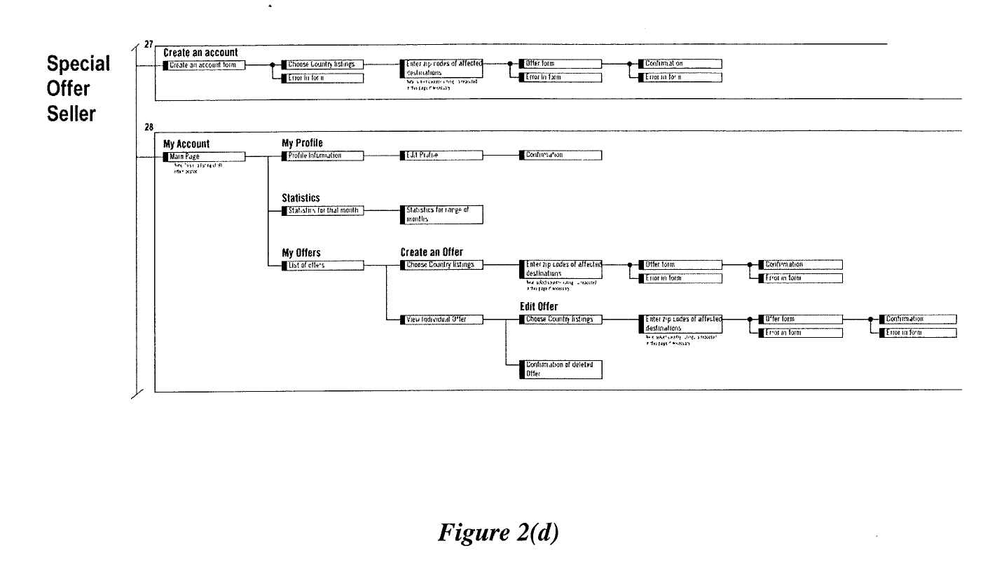

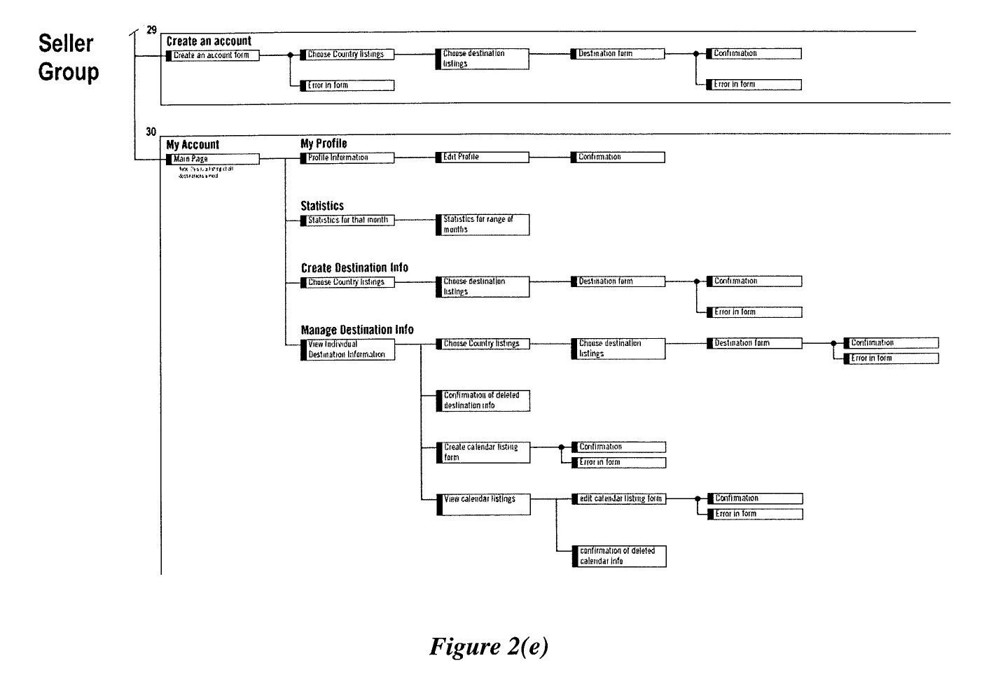

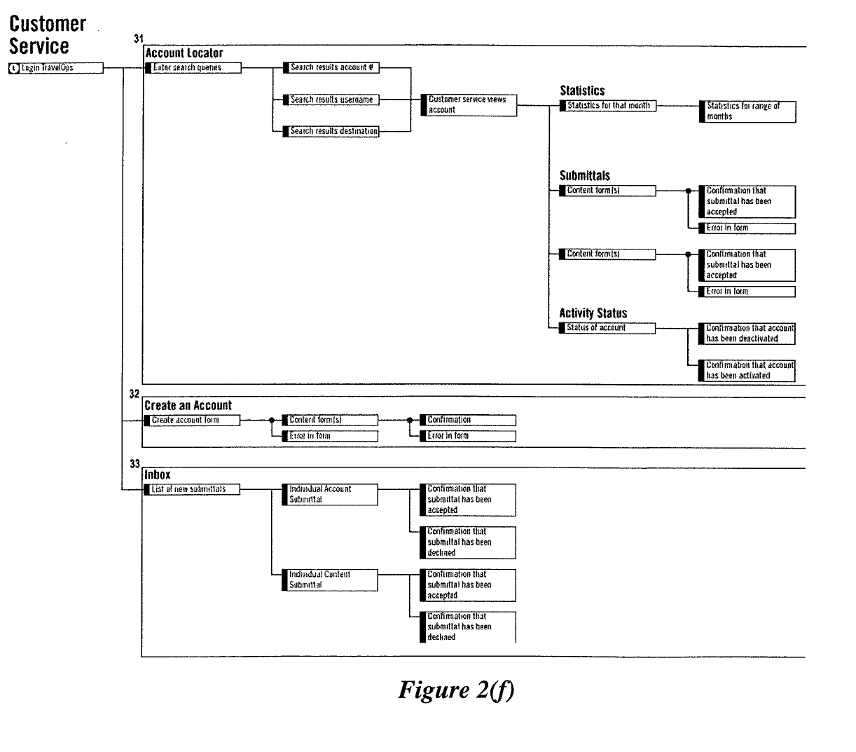

FIGS. 2(a)-(f) more particularly illustrate the preferred embodiments of the components of the present invention embodied in Web Server 14, Data Source Interface 15, Data Source 16, and Email Server 17. In the example shown in FIGS. 2(a)-(f), the system is used to facilitate transactions involving travel properties (e.g., airline tickets, hotel/resort bookings, car rental, etc.). It will be appreciated by those of skill in the art, however, that the system of the present invention is not specifically limited thereto, and can be used to facilitate many types of transactions, unrelated to travel, such as real estate, consumer products, etc.

The components of the system of the present invention preferably include Validation, Buyer, Seller, Special Offer Seller (SOS), Seller Group, and Customer Service.

As shown in FIG. 2(a), the Validation component is used to allow users (buyers, sellers, etc.) to log into Information Exchange System 13. This may be accomplished using Login Page 18, which may comprise an Web page generated by Web Server 14, Data Interface 15, and Data Source 16, as previously described. This Web page (and all Web pages hereinafter described) may be generated in a variety of forms well known to those of skill in the art, such as dynamic HTML, XML, or ASP (Active Server Pages), although not limited thereto. Login Page 18 will return Last Page Visited 19 (if the user name and password are validated), or Error Page 20 (if the user does is not validated).

As Shown in FIG. 2(b), the Buyer component may include Account Creator 21, Property Search System 22, Profiler 23 and Information System 24. Account Creator 21 allows Buyers to create an account (preferably a free account, without the need for providing credit card or payment related information, although not limited thereto) with Information Exchange System 13, through which they can establish and modify their user profile using Profiler 23. By establishing a user account, Buyers can also conduct searches for various desired properties through Property Search System 22.

By allowing Buyers to establish a profile of preferences through Profiler 23, the present invention provides the significant advantage that when a consumer conducts a property search through Property Search System 22, Property Search System 22 can interact with Profiler 23 to create a weighted search that is specifically targeted to the consumer's preferences.

For example, Profiler 23 may comprise a table of preferences in a relational database that are associated with the Buyer's user account. When the user conducts a search, Data Source Interface 15 extracts these preferences from Data Source 16 and uses them to filter the search results, also extracted by Data Source Interface 15 from Data Source 16. This search/filtering operation is well known to those of skill in the art and can comprise pattern matching, text sub-string searches, etc.

Profiler 23 also has the significant advantage that it allows the Buyer to save properties uncovered by Property Search System 22 in the user's profile, and to submit a Rate Request (i.e. an offer) for that property (which may be forwarded to the Seller of that Property, e.g. an Operator, SOS, or Tourist Board, via Email Server 17).

Information System 24 provides the Buyer with feedback and information relating to Information Exchange System 13, such as Frequently Asked Questions (FAQ's) about the its system, contacting the operators of the system, news updates, etc.

As Shown in FIG. 2(c), the Seller Component may include Account Creator 25, which may, of course, utilize portions of buyer Account Creator 19. Account Creator 25 allows Sellers (such as travel property operators) to create their own account so that they can submit one or more properties for sale through Information Exchange System 13.

Sellers can also create their own profile using Profiler 26, which may utilize portions of Buyer Profiler 23. Using Profiler 26, sellers can submit, change, and delete information about themselves and their properties. They can also establish secondary accounts for individual properties or groups of properties and view statistics for those properties. The statistics may be compiled directly by Information Exchange System 13, in a conventional manner, and may include, number of page views by buyers, a breakdown of buyer characteristics, etc. The Buyer characteristic statistics are compiled in conjunction with Profiler 23, which records specific Buyer preferences in Data Source 16, preferably using the same relational table system previously described. Using Profiler 26, Sellers can also respond to Rate Requests from Buyers. These responses may also be sent using Email Server 17.

As shown in FIG. 2(d), the SOS component may include an Account Creator 27, which again may utilize portions of the aforementioned account creators. The SOS component may also include its own Profiler 28, which allows the SOS to create a special offer for a ID property. This special-offer property may be searched for by the buyer as an option when using Property Search System 22. The special-offer property may comprise a collection of properties bundled together, for example, a vacation package that includes airfare, hotel, meals, etc. Just as with Seller Profiler 26, an SOS can submit, edit, or delete the special offer property, and can review special-offer property statistics. The SOS can also respond to a request for the special offer by email, in a similar manner to Sellers. The special offer request may be submitted by the buyer in the same manner as a Rate Request.

As shown in FIG. 2(e), the Seller Group component may include a similar Account Creator 29, allowing individual Seller Groups (e.g., an association representing a collection of sellers, such as a tourist board that represents resort property operators) to create their own accounts. Using Profiler 30, Seller Groups can also submit, edit, and delete properties, view statistics thereon, and respond to requests from Buyers. For example, if the Seller Group is a tourist board, they may submit a destination as the property, and can review inquiries from Buyers who are interested in visiting that location.

As shown in FIG. 2(f), the Customer Service component may include Account Locator 31, Account Creator 32, and Inbox 33. Account Locator 31 allows administrators of Information Exchange System 13 to review and maintain Buyer, Seller, SOS, and Seller Group accounts, compile user statistics, etc. Account Creator 32 allows the administrators to create additional accounts or to modify the parameters of existing accounts and user profiles. For example, if Data Source Interface 15, and Data Source 16 are a relational database system, Account Creator 32 would allow administrators to modify the database schema using the conventional tools associated therewith. Inbox 33 allows the administrators to communicate with Buyers, Sellers, SOS's, and Seller Groups, preferably by email, as previously described.

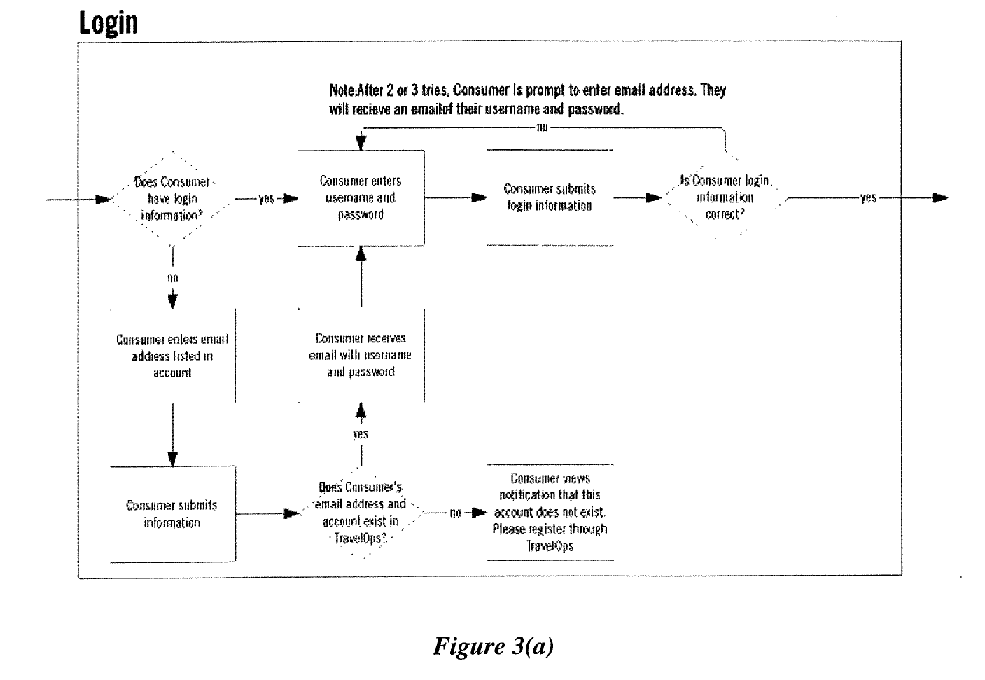

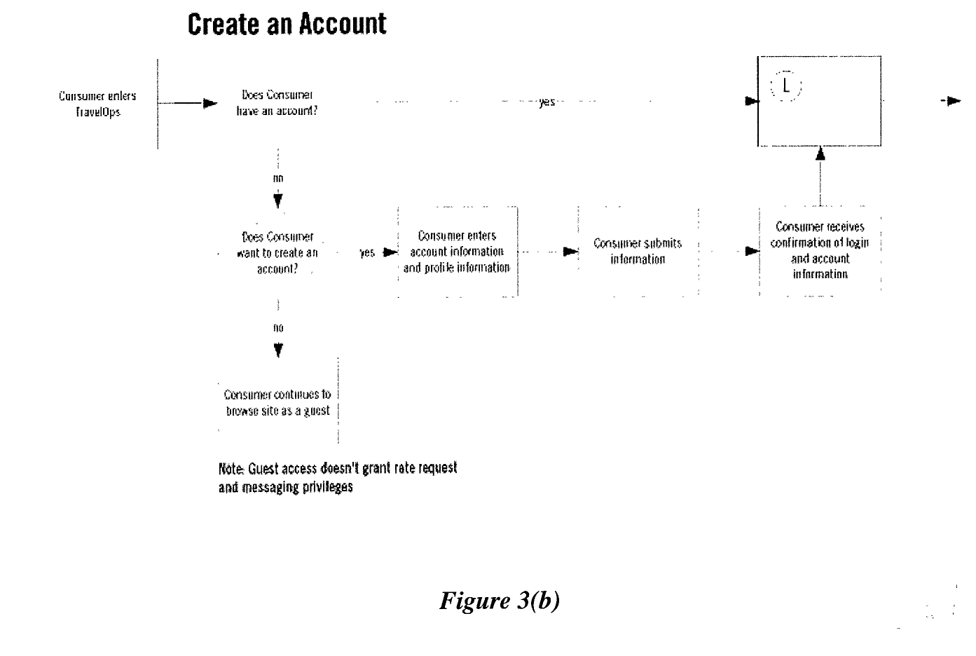

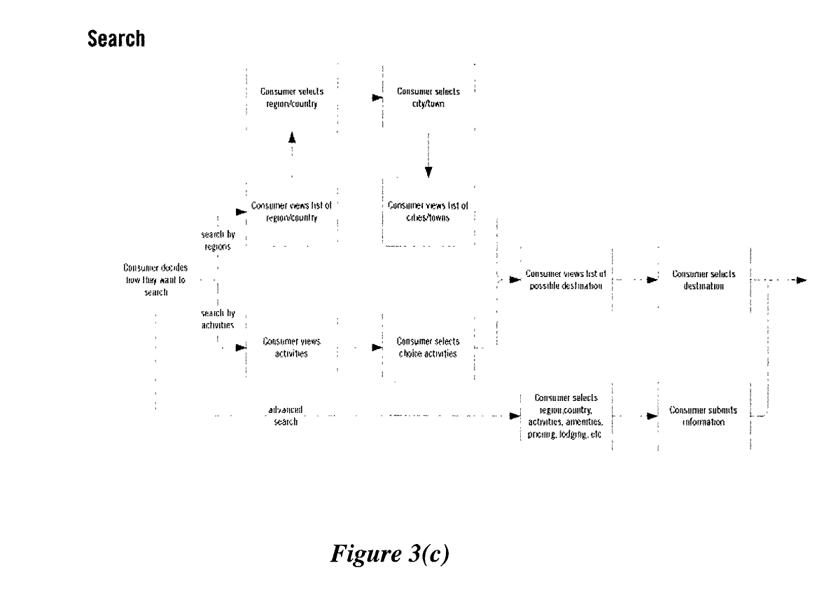

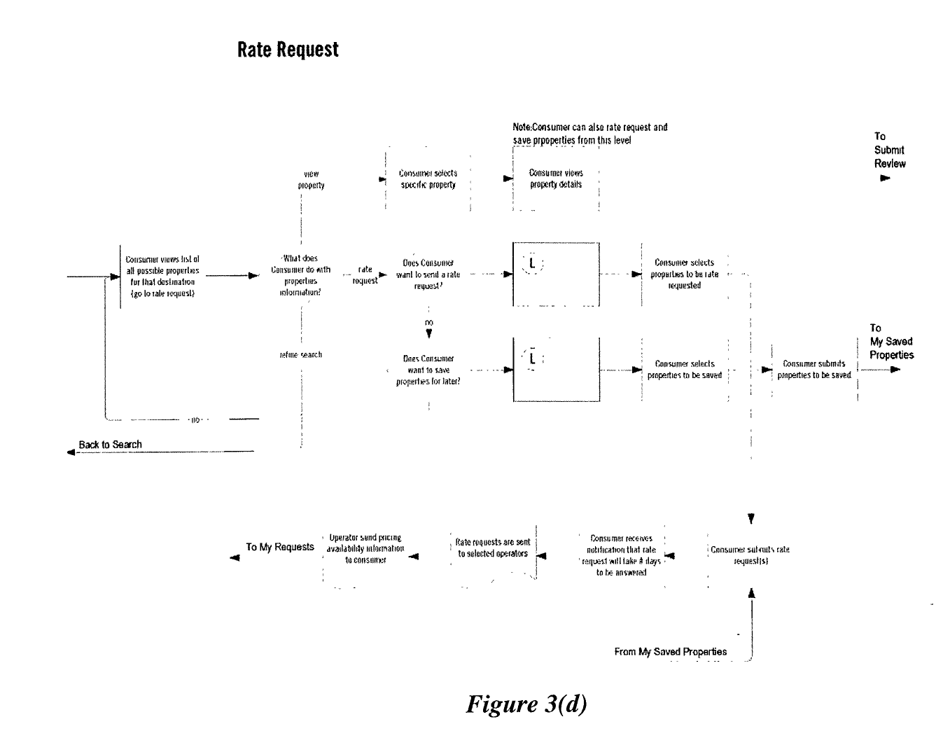

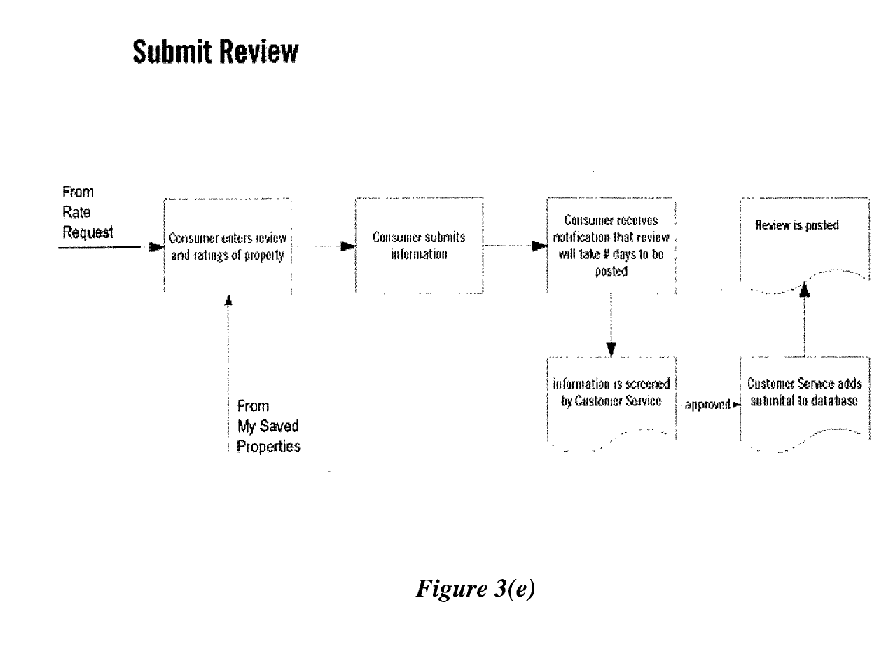

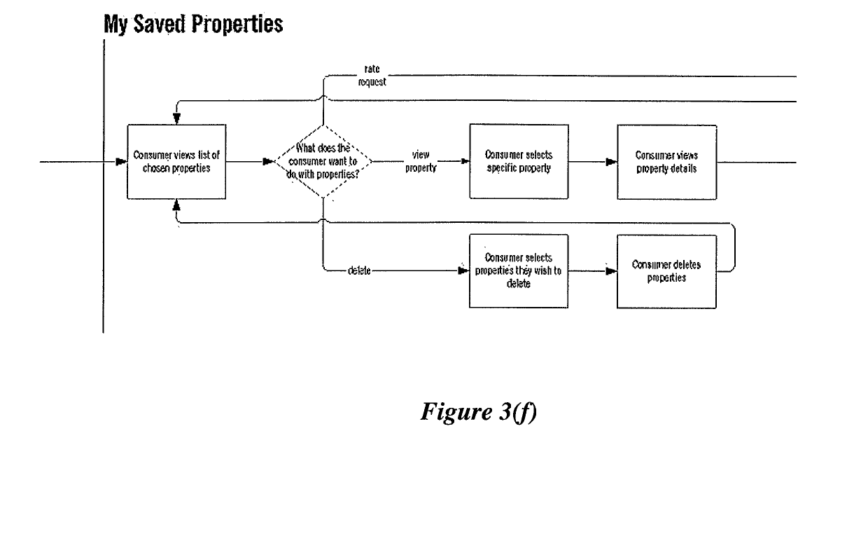

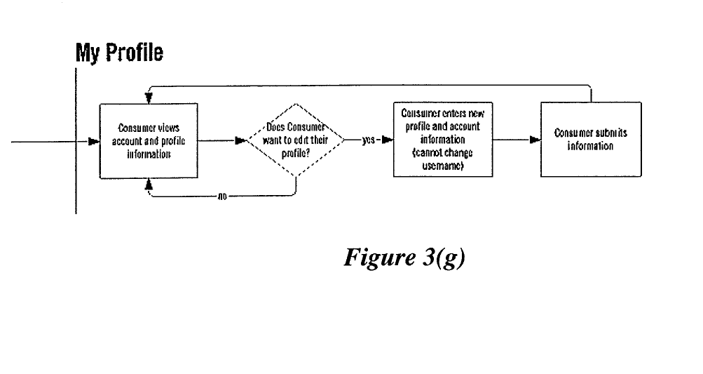

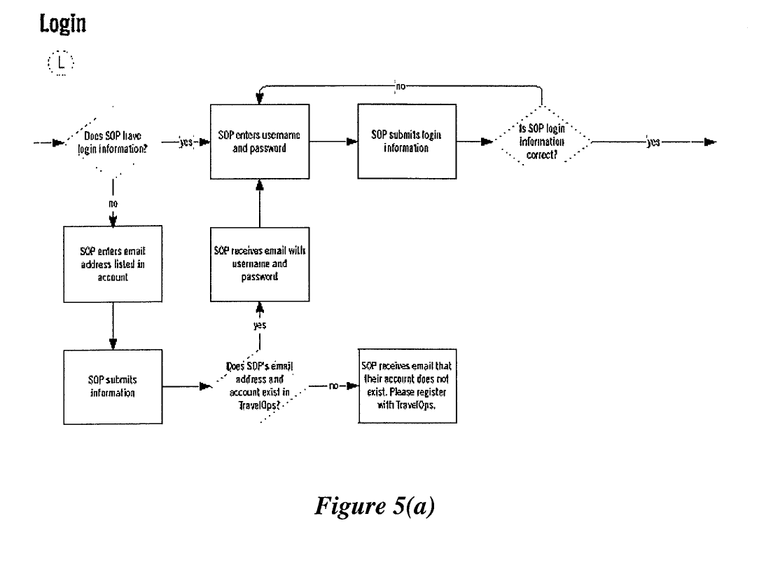

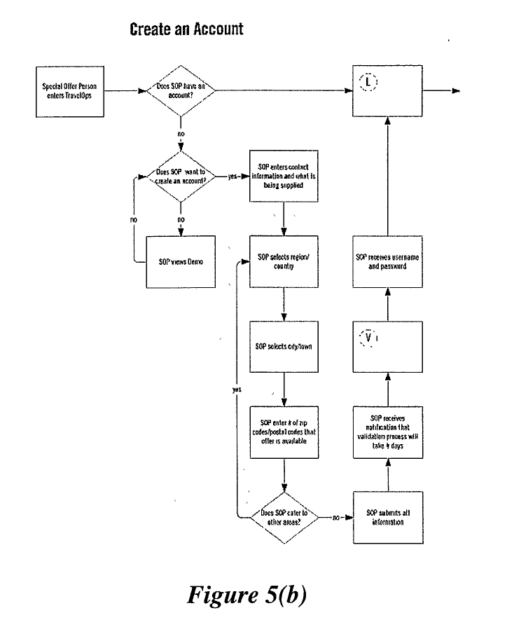

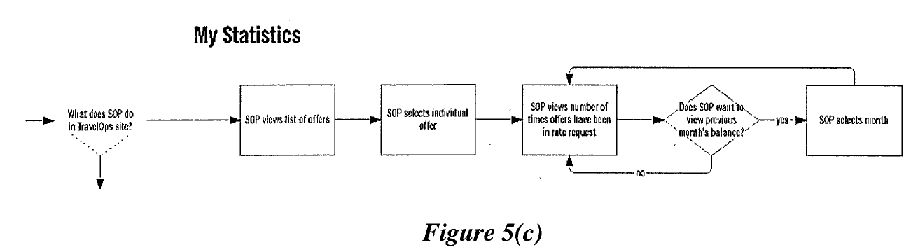

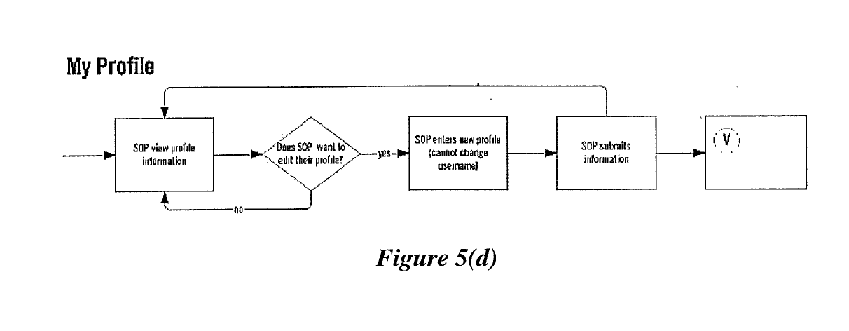

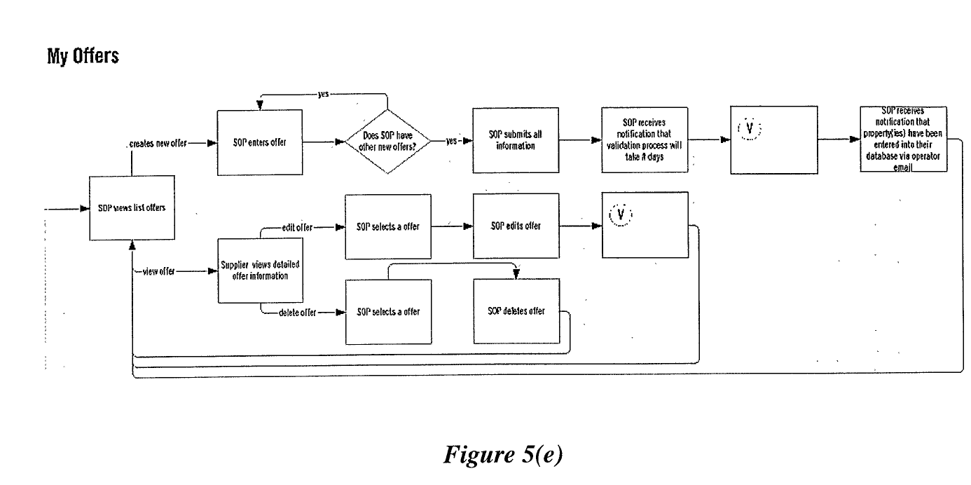

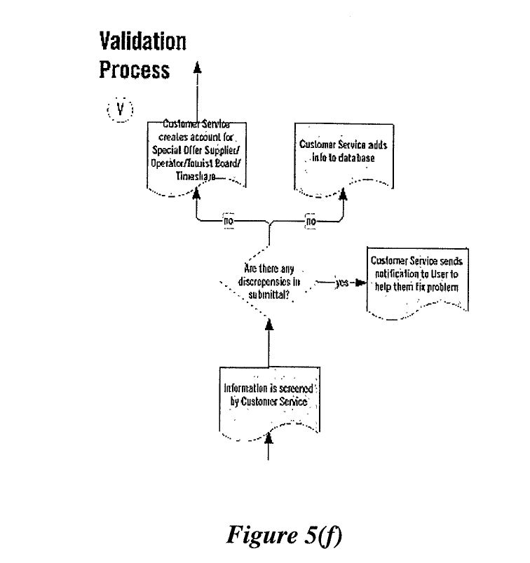

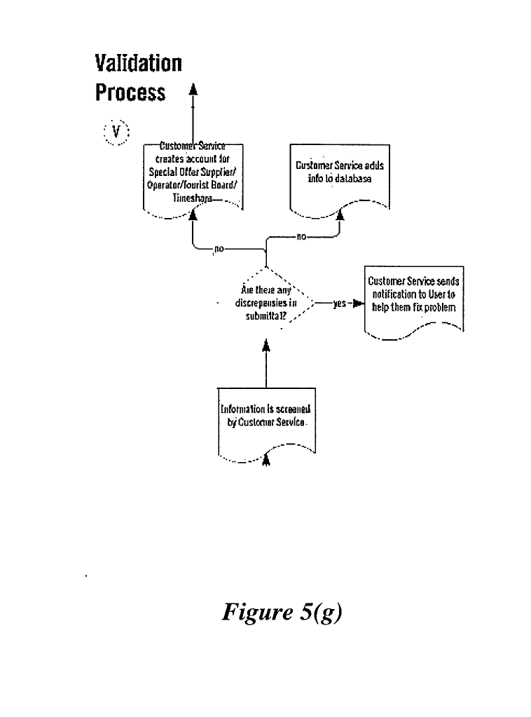

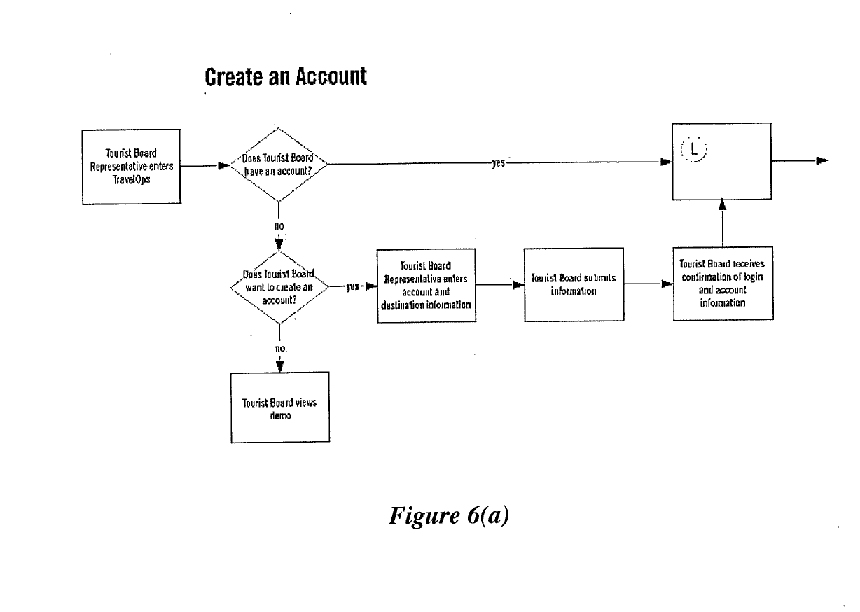

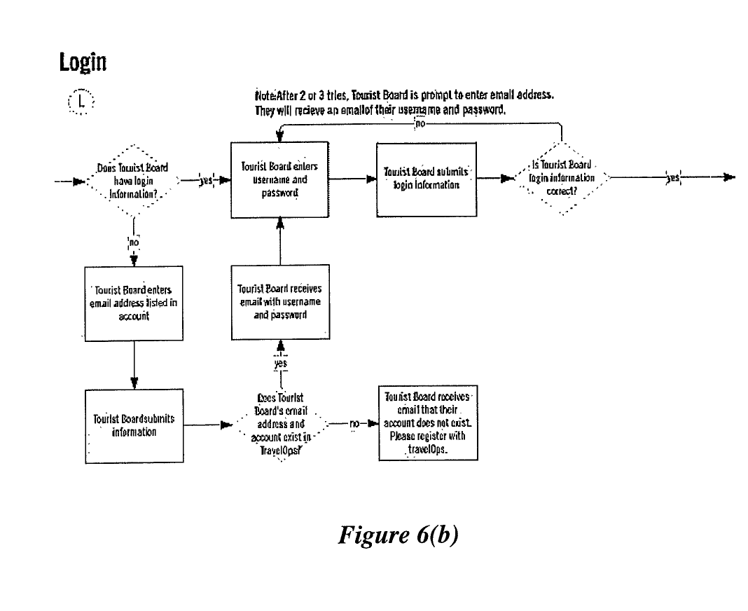

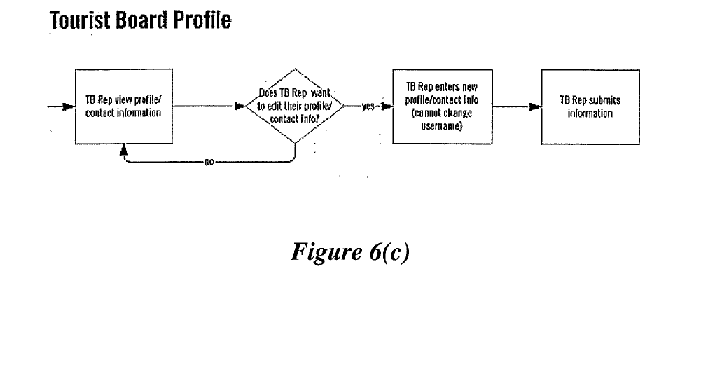

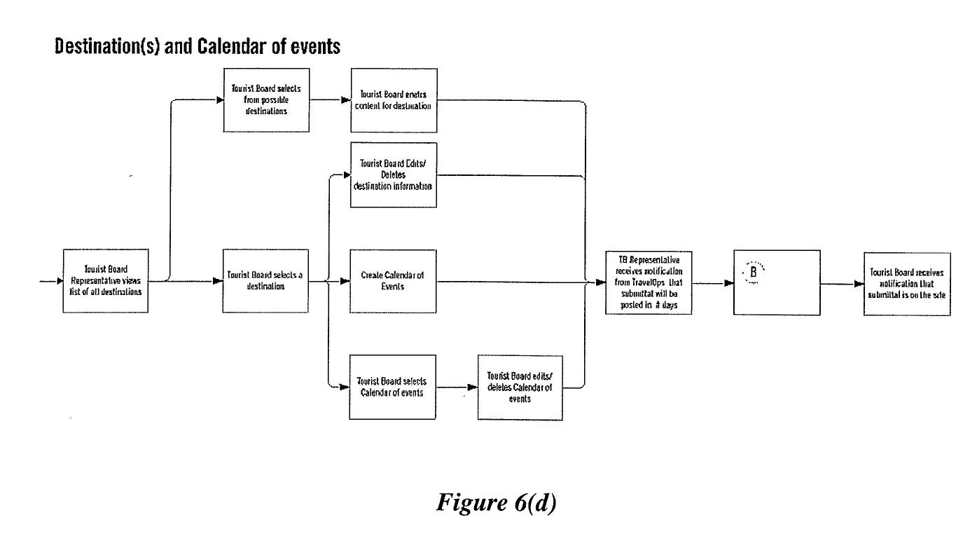

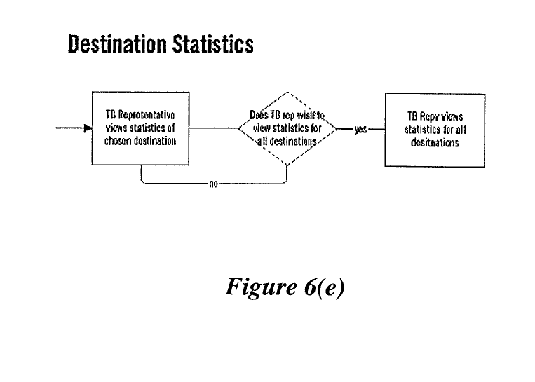

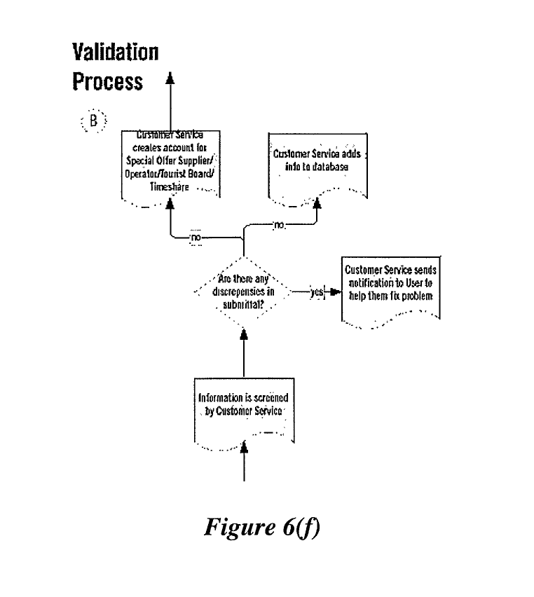

The specific operation of the system in regard to the various types of buyers, sellers, SOS's, and Seller Groups when the system of the present invention is used in the travel industry are illustrated in detail in FIGS. 3-6.

As shown in FIG. 3(a), when a user (e.g., a Buyer, a Seller, Seller Group, etc.) wishes to log into the system, the user is queried by Exchange System 13 as to whether or not the user already has an account (including a user name and password) stored in Exchange System 13. This may be accomplished in any number of conventional manners, such as through the use of HTML forms, or a “cookie” file stored on the user's computer—both of which are well known to those of skill in the art. If the user has the login information, then this information is entered and submitted to Exchange System 13, verified, and, if approved, the user is given access to the system.

If the user does not have the proper login information, then the user is prompted to submit identifying information, such as an email address, which is checked against Data Source 11 in a conventional manner. If this identifying information exists, then the user is sent a copy of the user name and password, preferably via email at the email address submitted. If the email address does not exist, then the user is preferably notified that the account does not exist and that one must be created.

The creation of a new account is illustrated in FIG. 3(b). The user enters the Web site (e.g. Information Exchange System 13), which prompts the user as whether the user has an existing account, if yes, then the user can log in, as previously described. If no, then the user is prompted as to whether the user wishes to create an account. To create an account, the user submits requested identifying information, such as name, email, travel preferences, etc. This information is used to create an account profile. A significant advantage of the present invention is the use of this profile information is to customize any searches and submissions of rate requests conducted by the user.

The submission of a search request for a travel destination is shown in FIG. 3(c). In this example, the consumer first decides how they wish to search: by geographic location or by activities. In the case of a search by location, the consumer selects from a list of available regions, cities, towns, etc. Information Exchange System 13 then retrieves a list of possible destinations by matching this request against information stored in Data Source 11. Similarly, the user can select from a list of activities, and Information Exchange System 13 will retrieve a list of possible destinations. Finally, in an advanced search capability, the consumer can enter a text string search, which may incorporate, for example, well known Boolean or natural language querying technology, to retrieve a list of possible destinations.

Thereafter, the consumer may create a rate request for a selected designation or group of designations, as shown in FIG. 3(d). Once the consumer views the list of all possible properties for a designated destination, the consumer may review each property, may go back and refine the search, or may submit a rate request. The consumer may also save these properties for later review or rate requests. After selecting the properties to be rate requested, the consumer submits the request to Information Exchange System 13 (which may return a notification that the request will take a predetermined length of time to responded to).

Information Exchange System 13 then sends the rate request to the selected operators. These operators may be selected by the consumer at the time of the request, may be stored with the saved properties or elsewhere in the consumer's profile. Alternatively, the operators may be selected by Exchange System 13. Once the operator receives the request, the operator sends a pricing availability response back to the consumer. These communications may be conducted via many means known to those of skill in the art, such as email or fax.

As shown in FIG. 3(e), if the consumer decides to review a property, the consumer may enter rating information for the property. This information is sent to Information Exchange System 13 and to customer service. After being approved by customer service, the review is posted on the Web site. This reviewing process may be accomplished through the previously described use of HTML forms and databases.

The process of viewing a saved property is shown in FIG. 3(f). As shown in FIG. 3(f), after the consumer selects and views a list of saved properties, the consumer can review the property or submit a rate request, as previously described, or can delete the property from the consumer's profile.

Consumers can edit their profiles as shown in FIG. 3(g). Consumers can edit both their account information and profile information. This can be accomplished through many means well known to those of skill in the art, such as through the use of HTML forms and database, as previously described.

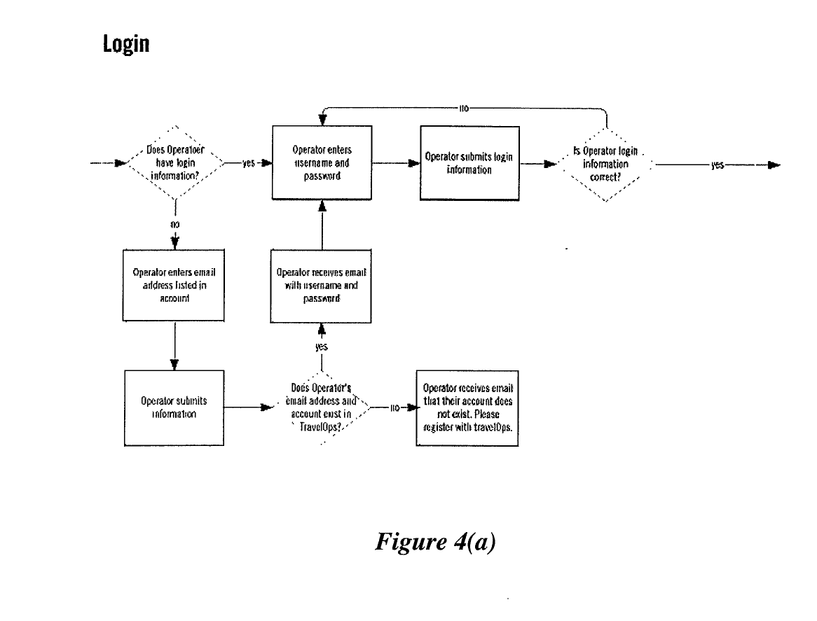

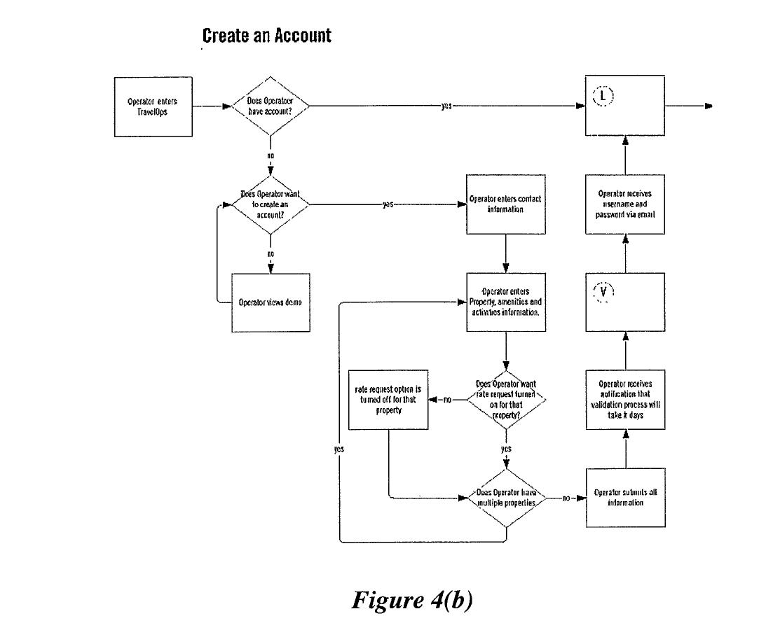

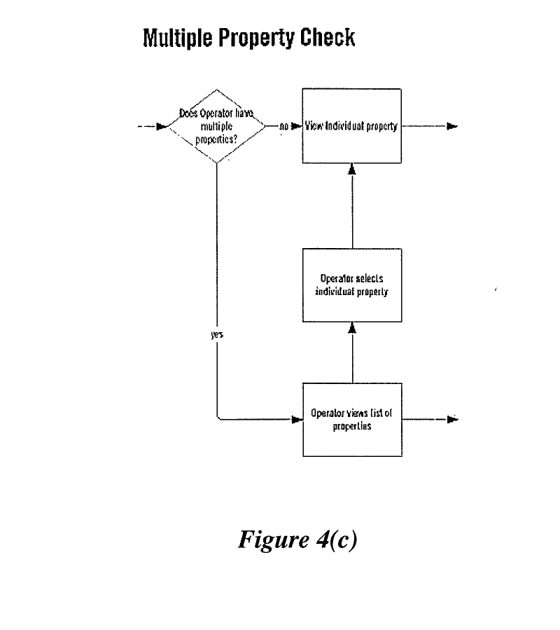

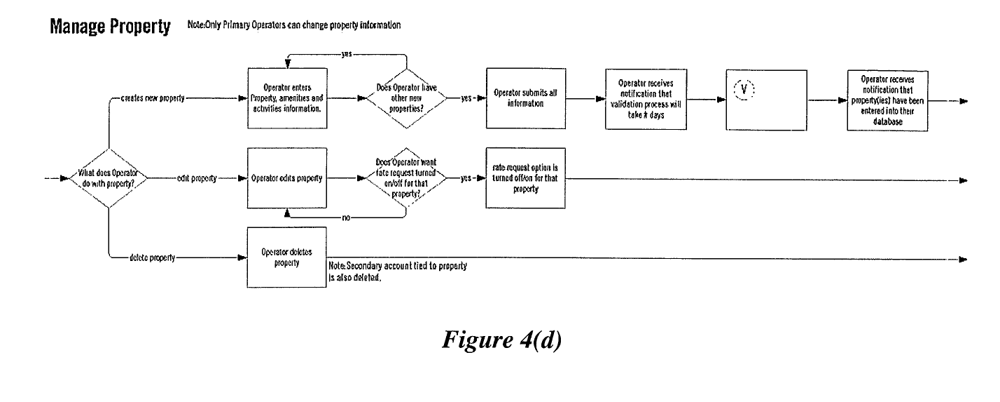

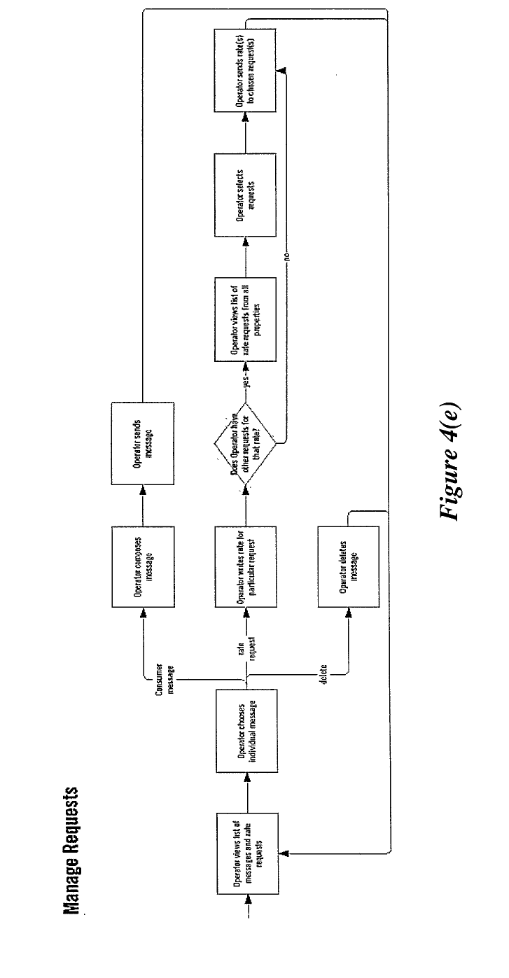

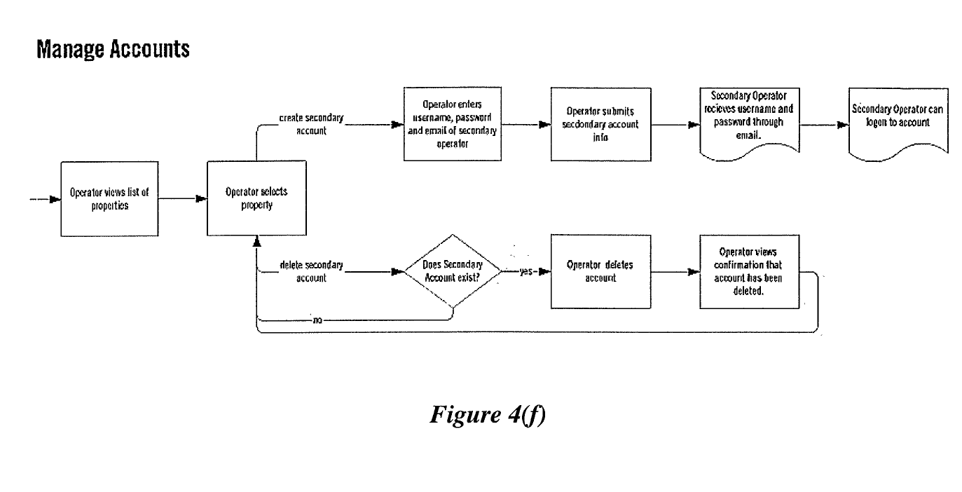

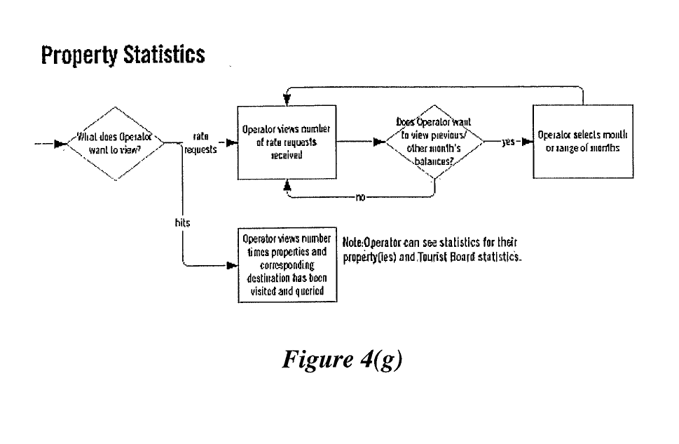

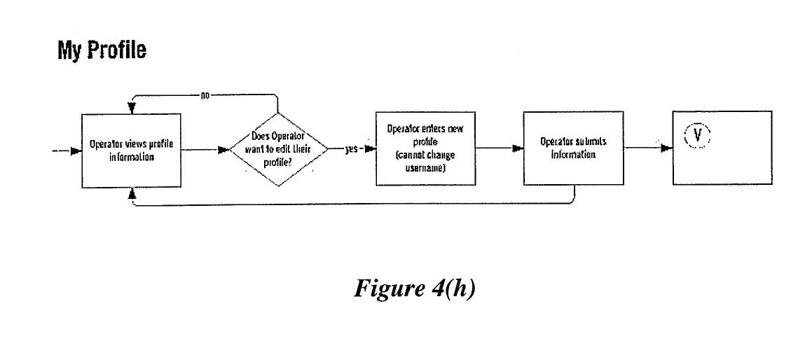

The operation of the system in connection with travel operators, Special Offer Person, and Tourist Boards may be accomplished through Exchange Server 13 in a manner similar to as for consumers as described above and as illustrated in detail in FIGS. 4-6.

The present invention provides the significant advantage over the prior art that it simultaneously provides incentives to both buyers and sellers, and specifically does not require buyers to submit payment information, such as a credit card, in order to use the system. Because of the system allows for the targeted searching of properties by buyers, sellers are not directly bidding against each other for all comers to a property, but instead, properties can be profiled to buyers based upon the buyer characteristics in the buyer's profile.

Although this invention has been described with reference to particular embodiments, it will be appreciated that many variations may be resorted to without departing from the spirit and scope of this invention. For example, the user interface, data source interface, and data source of the present invention may comprise a single software application, and may be operated from a single computer or a network of computers via the Internet or an internal intranet. Moreover, for example, a network of personal computers may be used, a mainframe system, or a server and peripheral thin clients.

I claim:

1. A method of facilitating a transaction between a buyer and a plurality of sellers for a product sold at quoted rate comprising the steps of:
establishing an information exchange system for exchanging information between said buyer and said plurality of sellers, said information exchange system being independent of said buyer and said plurality of sellers;
establishing a profile for said buyer in said information exchange system, said profile containing buyer information;
establishing an individual seller profile for each of said independent plurality of sellers in said information exchange system, each of said individual seller profiles containing seller information for said individual seller, said product information for at least one of said products offered by said individual seller, and statistics for said individual seller;
receiving a request for product information from said buyer;
compiling said product information from said individual seller profiles using said buyer information and said seller information;
transmitting said product information to said buyer;
receiving a rate request for said product from said buyer based upon said product information;
forwarding said rate request to said independent plurality of sellers;
receiving a reply from at least one of said sellers, wherein said reply may contain one or more selected from the group consisting of said quoted rate, an alternate product proposal, and a refusal; and
forwarding said reply to said buyer.

2. The method of claim 1, further comprising the steps of:
establishing a special offer seller profile for at least one special offer sellers in said information exchange system, said special offer seller being independent of said information exchange system; wherein said special offer seller profile contains seller information for said ID special offer seller, special offer formation for at least one product offered by said special offer seller, and statistics for said special offer seller; and
transmitting at least one of said special offers to said buyer based upon said buyer information.

3. The method of claim 1, further comprising the steps of:
establishing a seller group profile for at least one seller group in said information exchange system, said seller group being independent of said information exchange system; wherein said seller group profile contains seller group information for said seller group, offer formation for at least one product offered by said seller group, and statistics for said seller group; and
transmitting at least one of said seller group offers to said buyer based upon said buyer information.

4. The method of claim 1, wherein said buyer information comprises buyer preferences.

5. The method of claim 1, wherein said product is selected from one or more of the group consisting of lodging, airfare, car rental, boat rental, and vacation packages.

6. An information exchange system for facilitating a transaction between a buyer and a plurality of sellers for a product sold at quoted rate, said information exchange system being independent of said buyer and said plurality of sellers, said information exchange system being programmed to:
establish a profile for said buyer, said profile containing buyer information;
establish an individual seller profile for each of said independent plurality of sellers, each of said individual seller profiles containing seller information for said individual seller, said product information for at least one of said products offered by said individual seller, and statistics for said individual seller;
receive a request for product information from said buyer;
compile said product information from said individual seller profiles using said buyer information and said seller information;
transmit said product information to said buyer;
receive a rate request for said product from said buyer based upon said product information;
forward said rate request to said independent plurality of sellers;
receive a reply from at least one of said sellers, wherein said reply may contain one or more selected from the group consisting of said quoted rate, an alternate product proposal, and a refusal; and
forward said reply to said buyer.

7. The information exchange system of claim 6, wherein said information exchange system is further programmed to:
establish an special offer seller profile for at least one special offer sellers in said information exchange system, said special offer seller being independent of said information exchange system; wherein said special offer seller profile contains seller information for said special offer seller, special offer formation for at least one product offered by said special offer seller, and statistics for said special offer seller; and
transmit at least one of said special offers to said buyer based upon said buyer information.

8. The information exchange system of claim 6, wherein said information exchange system is further programmed to:
establish a seller group profile for at least one seller group in said information exchange system, said seller group being independent of said information exchange system; wherein said seller group profile contains seller group information for said seller group, offer formation for at least one product offered by said seller group, and statistics for said seller group; and
transmit at least one of said seller group offers to said buyer based upon said buyer information.

9. The information exchange system of claim 6, wherein said buyer information comprises buyer preferences.

10. The information exchange system of claim 6, wherein said product is selected from one or more of the group consisting of lodging, airfare, car rental, boat rental, and vacation packages.

11. An information exchange system for facilitating a transaction between a buyer and a plurality of sellers for a product sold at quoted rate, wherein said information exchange system is independent of said buyer and said plurality of sellers; said information exchange system comprising:
a data source;
a user interface in communication with said data source, said user interface being programmed to:
i) establish an individual seller profile for each of said independent plurality of sellers in said data source, each of said individual seller profiles containing seller information for said individual seller, said product information for at least one of said products offered by said individual seller, and statistics for said individual seller;
ii) establish a profile in said data source for said buyer containing buyer information; and
iii) to receive a request for product information from said buyer;
a data source interface in communication with said user interface and said data source, said data source interface being programmed to compile said product information from said individual seller profiles using said buyer information and said seller information, to transmit said product information to said buyer, to receive a rate request for said product from said buyer based upon said product information, to forward said rate request to said independent plurality of sellers, to receive a reply from at least one of said sellers, wherein said reply may contain one or more selected from the group consisting of said quoted rate, an alternate product proposal, and a refusal, and to forward said reply to said buyer.

12. The information exchange system of claim 11, wherein said user interface is further programmed to establish an special offer seller profile for at least one special offer sellers in said information exchange system, said special offer seller being independent of said information exchange system; wherein said special offer seller profile contains seller information for said special offer seller, special offer formation for at least one product offered by said special offer seller, and statistics for said special offer seller; and
said data source interface is further programmed to transmit at least one of said special offers to said buyer based upon said buyer information.

13. The information exchange system of claim 11, wherein said user interface is further programmed to establish a seller group profile for at least one seller group in said information exchange system, said seller group being independent of said information exchange system; wherein said seller group profile contains seller group information for said seller group, offer formation for at least one product offered by said seller group, and statistics for said seller group; and
said data source interface is further programmed to transmit at least one of said seller group offers to said buyer based upon said buyer information.

14. The information exchange system of claim 11, wherein said buyer information comprises buyer preferences.

15. The information exchange system of claim 11, wherein said product is selected from one or more of the group consisting of lodging, airfare, car rental, boat rental, and vacation packages.

16. The information exchange system of claim 11, wherein said data source is a relational database, said user interface is a Web server, and said data source interface is one or more selected from the group consisting of a CGI program, an API, and a set of interface tools for said relational database.

17. The information exchange system of claim 18, further comprising an email server for communicating among said buyer and said plurality of sellers.
